(19) United States
(12) Patent Application Publication
(10) Pub. No.: US 2025/0339949 A1
(43) Pub. Date: Nov. 6, 2025

(54) TOOL STORAGE DEVICE

(71) Applicant: CHUN NIEN PLASTIC LTD., Taichung City (TW)

(72) Inventor: CHI-TSAI CHANG, Taichung City (TW)

(21) Appl. No.: 19/194,337

(22) Filed: Apr. 30, 2025

(30) Foreign Application Priority Data
May 3, 2024 (TW) 113204446

(51) Int. Cl. B25H 3/00

(52) U.S. Cl. CPC B25H 3/003

(57) ABSTRACT

A tool storage device is provided, wherein the tool storage device includes: a first member including a first connection portion and a first clamping portion connected to each other; and a second member including an assembling portion, a second connection portion and a second clamping portion, the assembling portion and the second connection portion being disposed on opposing sides of the second clamping portion, the assembling portion being configured for a tool to be positioned thereto, the second connection portion being connected to the first connection portion, and the second clamping portion and the first clamping portion being configured to clamp a flexible substrate therebetween.

### BACKGROUND OF THE INVENTION

### Field of the Invention

The present invention relates to a storage device, particularly to a tool storage device.

### Description of the Prior Art

After a socket is removed from a package box or blister, it is usually stored in a toolbox. However, this storage method tends to cause the socket to roll freely within the toolbox, resulting in unnecessary collisions, or causes it to be hidden in components, making it difficult in use. Accordingly, socket storage devices have been developed to stably store sockets. A common socket storage device includes a slide bar and a socket seat. The socket seat is slidably disposed on the slide bar, and the socket is detachably sleeved on the socket seat so as to achieve storage or display.

However, such socket storage devices require a relatively large storage space, making them inconvenient for users to carry. Furthermore, the socket fixing mechanism of this type merely relies on spring plates for abutment positioning, which can cause the socket to easily fall off.

The present invention is, therefore, arisen to obviate or at least mitigate the above-mentioned disadvantages.

### SUMMARY OF THE INVENTION

The main object of the present invention is to provide a tool storage device that can be stably connected to a flexible substrate for positioning a tool. The flexible substrate significantly reduces the overall occupied volume, and the flexible substrate can reversely cover the tool for storage and carrying.

To achieve the above and other objects, a tool storage device is provided, wherein the tool storage device includes: a first member including a first connection portion and a first clamping portion connected to each other; and a second member including an assembling portion, a second connection portion and a second clamping portion, the assembling portion and the second connection portion being disposed on opposing sides of the second clamping portion, the assembling portion being configured for a tool to be positioned thereto, the second connection portion being connected to the first connection portion, and the second clamping portion and the first clamping portion being configured to clamp a flexible substrate therebetween.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view of an exemplary embodiment of the present invention;

FIG. 2 is an exploded view of FIG. 1;

FIG. 3 is another perspective view of FIG. 2;

FIG. 4 is a front view of a second member according to an exemplary embodiment of the present invention;

FIG. 5 is a cross-sectional view of FIG. 1;

FIG. 6 is another cross-sectional view of FIG. 1 from a different angle;

FIGS. 7 and 8 are schematic views showing rotation of a tool relative to an assembling portion in an exemplary embodiment;

FIG. 9 is a cross-sectional view of FIG. 8; and

FIG. 10 is a perspective view of another exemplary embodiment of the present invention.

### DETAILED DESCRIPTION OF THE PREFERRED EMBODIMENTS

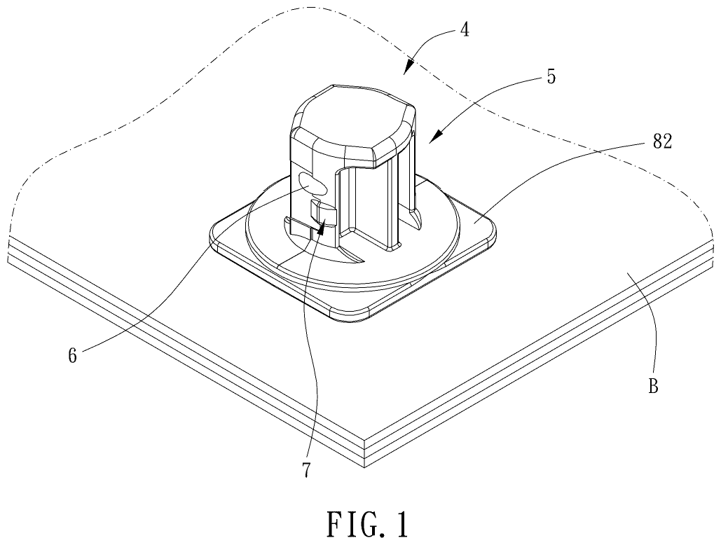

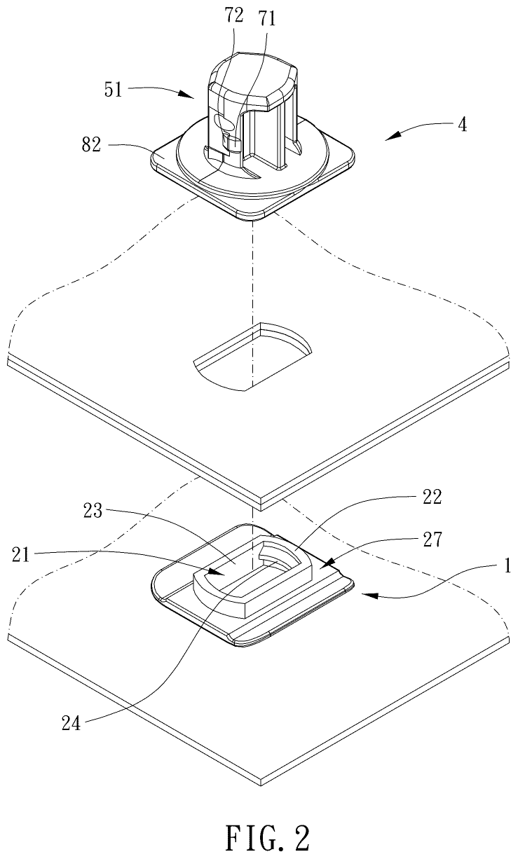

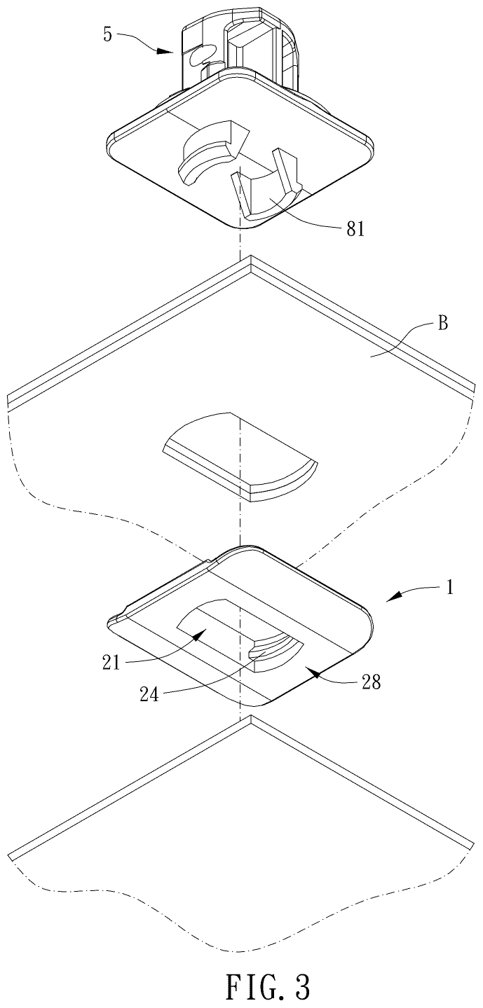

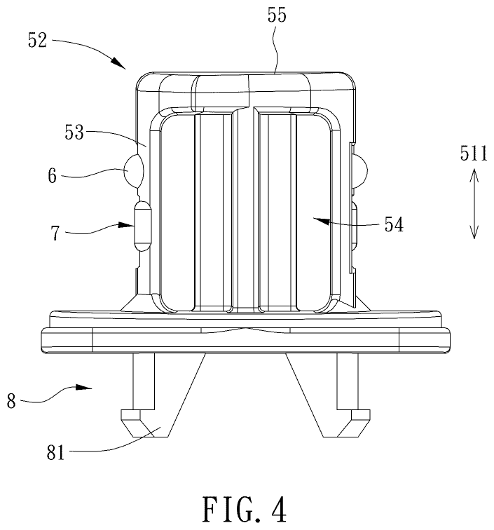

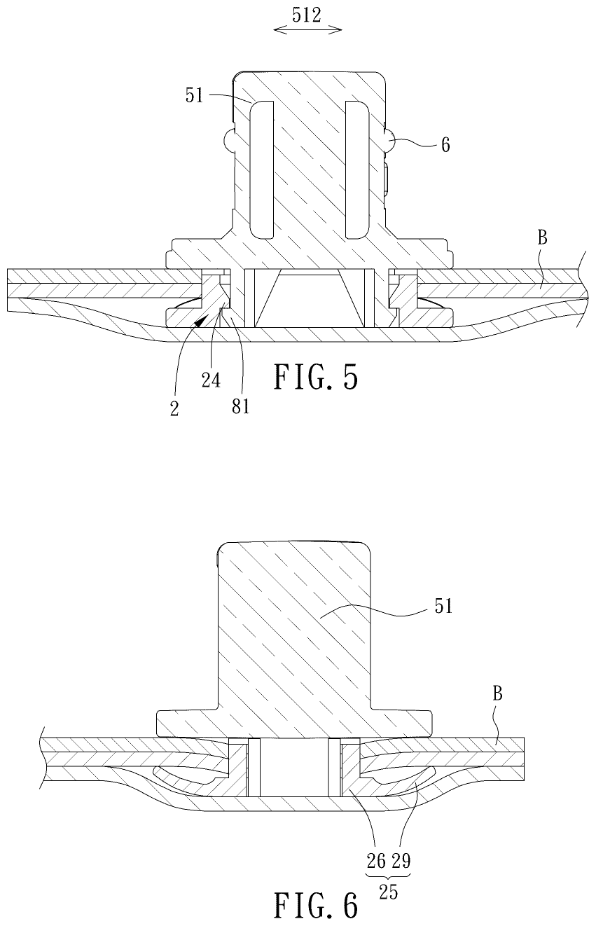

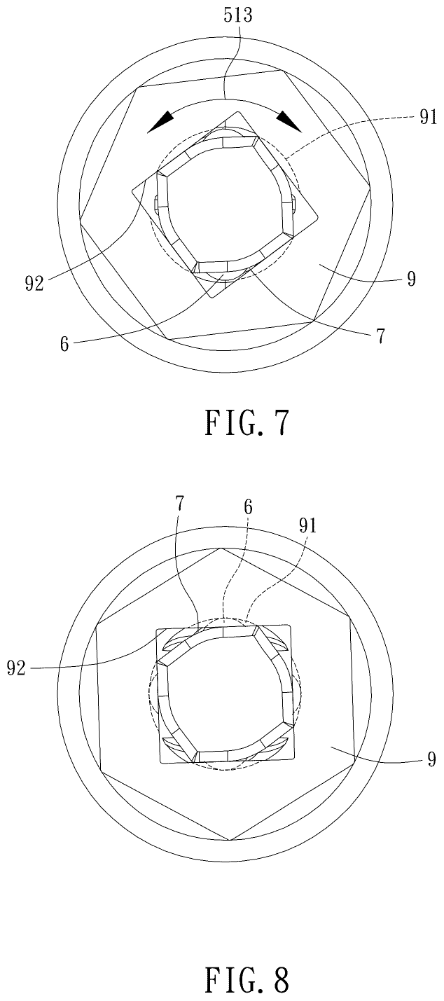

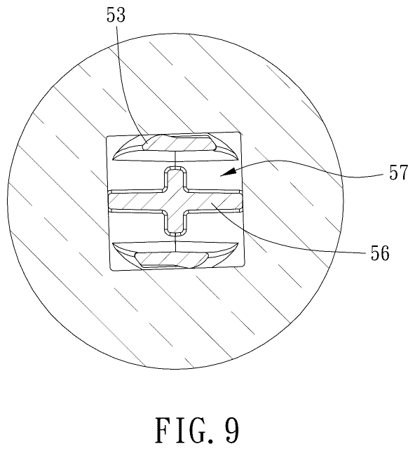

Please refer to FIGS. 1 to 9 for an exemplary embodiment of the present invention. A tool storage device of the present invention includes a first member 1 and a second member 4.

The first member 1 includes a first connection portion 2 and a first clamping portion 25 connected to each other. The second member 4 includes an assembling portion 5, a second connection portion 8 and a second clamping portion 82. The assembling portion 5 and the second connection portion 8 are disposed on opposing sides of the second clamping portion 82. The assembling portion 5 is configured for a tool 9 (e.g., a socket) to be positioned thereto. The second connection portion 8 is connected to the first connection portion 2. The second clamping portion 82 and the first clamping portion 25 are configured to clamp a flexible substrate B therebetween. The flexible substrate B is deformable and bendable, allowing it to vary in shape according to the storage space. This enables efficient use of various spaces, making it convenient for users to store and carry. Furthermore, the flexible substrate B can cover the tool 9 for positioning and protection.

Specifically, one of the first connection portion 2 and the second connection portion 8 includes a through hole 21 and a base 22, and the other of the first connection portion 2 and the second connection portion 8 includes at least one arm 81. The through hole 21 is disposed in the base 22. The at least one arm 81 is inserted in the through hole 21 and combined to the base 22. More specifically, the through hole 21 is disposed through the base 22. The base 22 includes a wall 23 and at least one blocking projection 24. The wall 23 surrounds the through hole 21. The at least one blocking projection 24 protrudes from the wall 23. The at least one arm 81 abuts against the at least one blocking projection 24 in an opening direction of the through hole 21.

In this embodiment, the first connection portion 2 includes the through hole 21 and the base 22. The base 22 is connected to the first clamping portion 25. The second connection portion 8 includes the at least one arm 81. The at least one arm 81 protrudes from the second clamping portion 82. When the at least one arm 81 is combined to the base 22, the base 22 abuts against the second clamping portion 82 so that the first clamping portion 25 and the second clamping portion 82 are spaced apart. Specifically, the at least one arm includes two arms 81, and the two arms 81 extend divergently away from the second clamping portion 82 and are in a V-shape arrangement.

The first clamping portion 25 includes a body portion 26 and at least one wing 29 connected to each other. The first connection portion 2 is disposed on the body portion 26. The body portion 26 includes a first side 27 and a second side 28. The first side 27 faces the second member 4. The second side 28 faces away from the second member 4. The at least one wing 29 bends in a direction from the second side 28 toward the first side 27 and toward the second member 4, thereby securely clamping the flexible substrate B for positioning.

In this embodiment, the at least one wing includes two wings 29, and the two wings 29 are symmetrically disposed on opposing sides of the body portion 26. In the direction from the second side 28 toward the first side 27, the at least one wing 29 is not protrusive beyond the first connection portion 2.

The assembling portion 5 includes a main body 51, at least one positioning protrusion 6 and at least one resistance bump 7. The main body 51 extends transversely on the second clamping portion 82 and is configured for the tool 9 to be sleeved thereon. The main body 51 defines an axial direction 511 and a radial direction 512. The at least one positioning protrusion 6 and the at least one resistance bump 7 protrude radially from the main body 51. The at least one positioning protrusion 6 is configured to be engaged within at least one positioning hole 91 of the tool 9. The at least one resistance bump 7 is configured to abut an inner wall 92 of the tool 9. As a result, the assembling portion 5 and the tool 9 are stably and firmly engaged so that the tool 9 does not loosely move relative to the main body 51. The user may rotate the tool 9 to lock it on or release it from the assembling portion 5, enabling convenient operation and good stability.

The main body 51 includes a hood portion 52 and a support bar 56. The hood portion 52 is disposed on the second clamping portion 82 to define an interior space 57. The hood portion 52 includes two side walls 53, two hollow portions 54 and a top wall 55. An outer contour of the top wall 55 is octagonal. The two side walls 53 are symmetrically connected to opposing sides of the top wall 55. The two side walls 53 define the hollow portion 54 therebetween. The at least one positioning protrusion 6 and the at least one resistance bump 7 are disposed on at least one of the two side walls 53. The support bar 56 is received in the interior space 57 and connected to the top wall 55 and the second clamping portion 82. The support bar 56 is not connected to the two side walls 53, thereby enabling the two side walls 53 to elastically deform.

Preferably, in the axial direction 511, the at least one positioning protrusion 6 and the at least one resistance bump 7 are offset with respect to each other. As such, the at least one positioning protrusion 6 and the at least one resistance bump 7 support the tool 9 at different ranges in the axial direction 511, thereby allowing the tool 9 to be stably and firmly engaged to the assembling portion 5.

Preferably, in the radial direction 512, a height of the at least one positioning protrusion 6 is greater than a height of the at least one resistance bump 7, ensuring that the at least one positioning protrusion 6 is reliably engaged within the at least one positioning hole 91.

In this embodiment, the main body 51 further defines a circumferential direction 513. The at least one positioning protrusion 6 has a hemispherical shape for smooth sliding engagement with or disengagement from the at least one positioning hole 91. The at least one resistance bump 7 is hill-shaped for progressively increasing resisting force during rotational locking. The at least one resistance bump 7 includes a first surface 71 and a second surface 72 connected to each other. The second surface 72 is configured to abut the inner wall 92. In the circumferential direction 513, the first surface 71 is longer than the second surface 72.

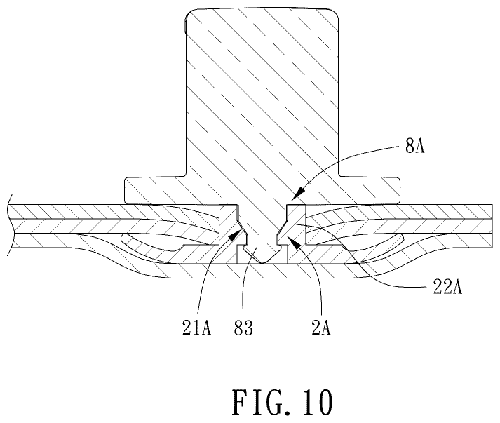

Please refer to another exemplary embodiment shown in FIG. 10. One of a first connection portion 2a and a second connection portion 8a includes a through hole 21a and a base 22a, and an other of the first connection portion 2a and the second connection portion 8a includes at least one engaging portion 83. The through hole 21a is disposed in the base 22a. The at least one engaging portion 83 is inserted in the through hole 21a and engaged with the base 22a. The at least one engaging portion 83 has a mushroom-head shape and can be hooked on the base 22a.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A tool storage device including:
a first member including a first connection portion and a first clamping portion connected to each other; and
a second member including an assembling portion, a second connection portion and a second clamping portion, the assembling portion and the second connection portion being disposed on opposing sides of the second clamping portion, the assembling portion being configured for a tool to be positioned thereto, the second connection portion being connected to the first connection portion, and the second clamping portion and the first clamping portion being configured to clamp a flexible substrate therebetween.

2. The tool storage device of claim 1, wherein one of the first connection portion and the second connection portion includes a through hole and a base, and an other of the first connection portion and the second connection portion includes at least one arm, the through hole is disposed in the base, and the at least one arm is inserted in the through hole and combined to the base.

3. The tool storage device of claim 2, wherein the through hole is disposed through the base, the base includes a wall and at least one blocking projection, the wall surrounds the through hole, the at least one blocking projection protrudes from the wall, and the at least one arm abuts against the at least one blocking projection in an opening direction of the through hole.

4. The tool storage device of claim 2, wherein the first connection portion includes the through hole and the base, the base is connected to the first clamping portion, the second connection portion includes the at least one arm, the at least one arm protrudes from the second clamping portion, and when the at least one arm is combined to the base, the base abuts against the second clamping portion so that the first clamping portion and the second clamping portion are spaced apart.

5. The tool storage device of claim 1, wherein the assembling portion includes a main body, at least one positioning protrusion and at least one resistance bump, the main body extends transversely on the second clamping portion and is configured for the tool to be sleeved thereon, the main body defines an axial direction and a radial direction, the at least one positioning protrusion and the at least one resistance bump protrude radially from the main body, the at least one positioning protrusion is configured to be engaged within at least one positioning hole of the tool, and the at least one resistance bump is configured to abut an inner wall of the tool.

6. The tool storage device of claim 5, wherein the at least one positioning protrusion and the at least one resistance bump are offset with respect to the axial direction.

7. The tool storage device of claim 5, wherein the main body includes a hood portion and a support bar, the hood portion is disposed on the second clamping portion to defines an interior space, the hood portion includes two side walls, two hollow portions and a top wall, the two side walls are symmetrically connected to opposing sides of the top wall, the two side walls define the hollow portion therebetween, the at least one positioning protrusion and the at least one resistance bump are disposed on at least one of the two side walls, the support bar is received in the interior space and connected to the top wall and the second clamping portion, and the support bar is not connected to the two side walls.

8. The tool storage device of claim 1, wherein the first clamping portion includes a body portion and at least one wing connected to each other, the first connection portion is disposed on the body portion, the body portion includes a first side and a second side, the first side faces the second member, the second side faces away from the second member, and the at least one wing bends in a direction from the second side toward the first side and toward the second member.

9. The tool storage device of claim 8, wherein in the direction from the second side toward the first side, the at least one wing is not protrusive beyond the first connection portion.

10. The tool storage device of claim 3, wherein the first connection portion includes the through hole and the base, the base is connected to the first clamping portion, the second connection portion includes the at least one arm, the at least one arm protrudes from the second clamping portion, and when the at least one arm is combined to the base, the base abuts against the second clamping portion so that the first clamping portion and the second clamping portion are spaced apart; the assembling portion includes a main body, at least one positioning protrusion and at least one resistance bump, the main body extends transversely on the second clamping portion and is configured for the tool to be sleeved thereon, the main body defines an axial direction and a radial direction, the at least one positioning protrusion and the at least one resistance bump protrude radially from the main body, the at least one positioning protrusion is configured to be engaged within at least one positioning hole of the tool, and the at least one resistance bump is configured to abut an inner wall of the tool; the at least one positioning protrusion and the at least one resistance bump are offset with respect to the axial direction; the main body includes a hood portion and a support bar, the hood portion is disposed on the second clamping portion to defines an interior space, the hood portion includes two side walls, two hollow portions and a top wall, the two side walls are symmetrically connected to opposing sides of the top wall, the two side walls define the hollow portion therebetween, the support bar is received in the interior space and is connected to the top wall and the second clamping portion, and the support bar is not connected to the two side walls; the first clamping portion includes a body portion and at least one wing connected to each other, the first connection portion is disposed on the body portion, the body portion includes a first side and a second side, the first side faces the second member, the second side faces away from the second member, and the at least one wing bends in a direction from the second side toward the first side and toward the second member; in the direction from the second side to the first side, the at least one wing is not protrusive beyond the first connection portion; the at least one wing includes two wings, and the two wings are symmetrically disposed on opposing sides of the body portion; the main body further defines a circumferential direction, the at least one positioning protrusion has a hemispherical shape, the at least one resistance bump includes a first surface and a second surface connected to each other, the second surface is configured to abut the inner wall, and in the circumferential direction, the first surface is longer than the second surface; in the radial direction, a height of the at least one positioning protrusion is greater than a height of the at least one resistance bump; an outer contour of the top wall is octagonal; the at least one arm includes two arms, and the two arms extend divergently away from the second clamping portion and are in a V-shape arrangement.

11. The tool storage device of claim 1, wherein one of the first connection portion and the second connection portion includes a through hole and a base, an other of the first connection portion and the second connection portion includes at least one engaging portion, the through hole is disposed in the base, and the at least one engaging portion is inserted in the through hole and engaged with the base.
